(19) United States
(12) Patent Application Publication
(10) Pub. No.: US 2016/0075860 A1
(43) Pub. Date: Mar. 17, 2016

(54) AN ETHYLENE-BASED COMPOSITION

(71) Applicant: DOW GLOBAL TECHNOLOGIES LLC, Midland, MI (US)

(72) Inventor: Rony S.L. Vansoeybroeck, Bellem (BE)

(21) Appl. No.: 14/888,020

(22) PCT Filed: May 23, 2014
(86) PCT No.: PCT/US14/39403

§ 371 Date: Oct. 29, 2015

Related U.S. Application Data
(60) Provisional application No. 61/827,172, filed on May 24, 2013.

(51) Int. Cl. C08K 5/5357; C08K 5/45; C08K 5/1545

(52) U.S. Cl. CPC C08K 5/5357; C08K 5/1545; C08K 5/45

(57) ABSTRACT

The instant invention provides an ethylene-based composition and method of improving stabilization thereof. The inventive ethylene-based composition comprises: (a) a linear low density polyethylene (LLDPE) comprising units derived from ethylene and optionally one or more alpha-olefin comonomers; (b) from 20 to 500 part by weight of a primary antioxidant comprising 3,4-Dihydro-2,5,7,8-tetramethyl-2-(4,8,12-trimethyltridecyl)-2H-1-benzopyran-6-ol per one million parts of LLDPE; (c) optionally from 2 to 200 part by weight of an optical brightening agent; and (d) optionally from 20 to 1000 part by weight of a secondary antioxidant per one million parts of LLDPE.

### FIELD OF INVENTION

The instant invention relates to an ethylene-based composition and method of improving stabilization thereof.

### BACKGROUND OF THE INVENTION

The use of antioxidants to stabilize polymeric materials such as polyethylenes is generally known. Such antioxidants include, but are not limited to, primary and secondary antioxidants. However, there is need for further improving the stabilization of such polyethylenes while maintaining processability properties and/or improving color and color stability of such polyethylenes.

### SUMMARY OF THE INVENTION

The instant invention provides an ethylene-based composition and method of improving stabilization thereof.

In one embodiment, the instant invention provides an ethylene-based composition comprising: (a) a linear low density polyethylene (LLDPE) comprising units derived from ethylene and optionally one or more alpha-olefin comonomers; (b) from 20 to 500 part by weight of a primary antioxidant comprising 3,4-Dihydro-2,5,7,8-tetramethyl-2-(4,8,12-trimethyltridecyl)-2H-1-benzopyran-6-ol per one million parts of LLDPE; (c) optionally from 2 to 200 part by weight of an optical brightening agent; and (d) optionally from 20 to 1000 part by weight of a secondary antioxidant per one million parts of LLDPE.

In an alternative embodiment, the instant invention further provides a method of improving stabilization of LLDPE comprising the steps of: (1) selecting a linear low density polyethylene (LLDPE) comprising units derived from ethylene and optionally one or more alpha-olefin comonomers; (2) selecting a primary antioxidant comprising from 20 to 500 part by weight of 3,4-Dihydro-2,5,7,8-tetramethyl-2-(4,8,12-trimethyltridecyl)-2H-1-benzopyran-6-ol per one million parts of LLDPE; (3) optionally selecting from 2 to 200 part by weight of an optical brightening agent; (4) optionally selecting from 20 to 1000 part by weight of a secondary antioxidant; and (5) contacting 1-4; (6) thereby forming a stabilized LLDPE.

In an alternative embodiment, the instant invention provides an ethylene-based composition, a method of improving stabilization of LLDPE, in accordance with any of the preceding embodiments, except that the LLDPE has a yellowness index of from −35 to 10.

### DETAILED DESCRIPTION OF THE INVENTION

The instant invention provides an ethylene-based composition and method of improving stabilization thereof. The ethylene-based composition according to the present invention comprises (a) a linear low density polyethylene (LLDPE) comprising units derived from ethylene and optionally one or more alpha-olefin comonomers; (b) from 20 to 500 part by weight of a primary antioxidant comprising 3,4-Dihydro-2,5,7,8-tetramethyl-2-(4,8,12-trimethyltridecyl)-2H-1-benzopyran-6-ol per one million parts of LLDPE; (c) optionally from 2 to 200 part by weight of an optical brightening agent; and (d) optionally from 20 to 1000 part by weight of a secondary antioxidant per one million parts of LLDPE.

The ethylene-based composition has a yellowness index in the range of from −35 to 10, for example, in the range of from −25 to 5.

### Linear Low Density Polyethylene (LLDPE) Component

The ethylene-based composition comprises at least 50% by weight of a linear low density polyethylene (LLDPE); for example, at least 60 weight percent, or at least 70 weight percent, or at least 80 weight percent, or at least 90 weight percent, or at least 95 weight percent.

The linear low density polyethylene (LLDPE) comprises (a) less than or equal to 100 percent, for example, at least 70 percent, or at least 80 percent, or at least 90 percent, by weight of the units derived from ethylene; and (b) less than 30 percent, for example, less than 25 percent, or less than 20 percent, or less than 10 percent, by weight of units derived from one or more α-olefin comonomers. The term “linear low density polyethylene” refers to a polymer that contains more than 50 mole percent polymerized ethylene monomer (based on the total amount of polymerizable monomers) and, optionally, may contain at least one comonomer.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

The LLDPE has a density in the range of 0.903 to 0.950 g/cm³. For example, the density can be from a lower limit of 0.903, 0.905, 0.908, 0.910, or 0.912 g/cm³ to an upper limit of 0.925, 0.935, 0.940, 0.945, 0.950 g/cm³.

The LLDPE has a molecular weight distribution (M_{w}/Mₙ) in the range of from 1.8 to 5. For example, the molecular weight distribution (M_{w}/Mₙ) can be from a lower limit of 1.8, 2, 2.1, or 2.2 to an upper limit of 2.5, 2.7, 2.9, 3.2, 3.5, 4.o, 4.5, 5.0.

The LLDPE has a melt index (I₂) in the range of 0.1 to 100 g/10 minutes. For example, the melt index (I₂) can be from a lower limit of 0.1, 0.2, 0.5, or 0.8 g/10 minutes to an upper limit of 1.2, 1.5, 1.8, 2.0, 2.2, 2.5, 3.0, 4.0, 4.5, 5.0, 20, 50, or 100 g/10 minutes.

The LLDPE has a molecular weight (M_{w}) in the range of 50,000 to 250,000 daltons. For example, the molecular weight (M_{w}) can be from a lower limit of 50,000, 60,000, 70,000 daltons to an upper limit of 150,000, 180,000, 200,000 or 250,000 daltons.

The LLDPE may further comprise additional components such as one or more other polymers and/or one or more additives. Such additives include, but are not limited to, antistatic agents, color enhancers, dyes, lubricants, fillers such as TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti fungal agents, and combinations thereof. The LLDPE may contain from about 0.1 to about 10 percent by the combined weight of such additives, based on the combined weight of the LLDPE and such additives.

Any conventional ethylene (co)polymerization reaction processes may be employed to produce the LLDPE. Such conventional ethylene (co)polymerization reaction processes include, but are not limited to, gas phase polymerization process, slurry phase polymerization process, solution phase polymerization process, and combinations thereof using one or more conventional reactors, e.g. fluidized bed gas phase reactors, loop reactors, stirred tank reactors, batch reactors in parallel, series, and/or any combinations thereof.

Such LLDPE are commercially available under the trade names DOWLEX®, ATTANE® or ELITE®, from The Dow Chemical Company.

### Primary Antioxidant Component

The ethylene-based composition comprises a primary antioxidant. The primary antioxidant is 3,4-Dihydro-2,5,7,8-tetramethyl-2-(4,8,12-trimethyltridecyl)-2H-1-benzopyran-6-ol. The ethylene-based composition comprises from 20 to 500 part by weight of the primary antioxidant per one million parts of the LLDPE. Such primary antioxidants are commercially available under the trade name Irganox E201 from BASF. The primary antioxidant may optionally further comprise one or more antioxidants such as Pentaerythritol tetrakis(3-(3,5-di-tert-butyl-4-hydroxyphenyl)propionate), CAS No. 6683-19-8, which is commercially available under the trade name Irganox® 1010 from BASF, and/or Calcium-bis(((3,5-bis(1,1-dimethylethyl)-4-hydroxyphenyl)methyl)-ethylphosphonate), CAS No. 65140-91-2, which is commercially available under the trade name Irganox 1425.

### Optical Brightening Agent Component

The ethylene-based composition optionally comprises from 2 to 200 part by weight of an optical brightening agent per one million parts of LLDPE. Such optical brightening agents include, but are not limited to, 2,5-thiophenediylbis(5-tert-butyl-1,3-benzoxazole); CAS No. 7128-64-5, which are commercially available under the trade name Tinopal OB from BASF.

### Secondary Antioxidant Component

The ethylene-based composition optionally comprises from 20 to 1000 part by weight of a secondary antioxidant per one million parts of LLDPE. Such secondary antioxidants include, but are not limited to, Tris(2,4-di-tert-butylphenyl)phosphite; CAS No. 31570-04-4, which are commercially available under the trade name Irgafos 168 from BASF.

### Production

The ethylene-based composition is prepared via any conventional melt blending process such as extrusion via an extruder, e.g. single or twin screw extruder. The LLDPE, primary antioxidant, and optionally optical brightening agent, and optionally one or more secondary antioxidants may be melt blended in any order via one or more extruders to form a uniform ethylene-based composition. In the alternative, LLDPE, primary antioxidant, and optionally optical brightening agent, and optionally one or more secondary antioxidants may be dry blended, or in the alternative, primary antioxidant, and optionally optical brightening agent, and optionally one or more secondary antioxidants can be added to the polymer solution or polymer slurry as they exit the reactor.

### Examples

The following examples illustrate the present invention but are not intended to limit the scope of the invention. The examples of the instant invention demonstrate that inventive ethylene-based compositions possess improved stability.

### Formulation Components:

Linear low density polyethylene-1 (LLDPE-1) is an ethylene-octene copolymer (DOWLEX® 2045S) having a target density of 0.930 g/cm³, and a melt index of 1.0 dg/min. As the LLDPE-1 exited the reactor, LLDPE 1 is treated with 1250 ppm calcium stearate to scavenge HCl that is released upon deactivation of the catalyst with water.
Linear low density polyethylene-2 (LLDPE-2) is an ethylene-octene copolymer having a target density of 0.930 g/cm³, and a melt index of 1.0 dg/min. As the LLDPE-1 exited the reactor, LLDPE 1 is treated with 300 ppm synthetic hydrotalcite to scavenge HCl that is released upon deactivation of the catalyst with water.
Irganox 1010 is Pentaerythritol tetrakis(3-(3,5-di-tert-butyl-4-hydroxyphenyl)propionate), CAS No. 6683-19-8.
Irganox 1076 is Octadecyl-3-(3,5-di-tert.butyl-4-hydroxyphenyl)-propionate, CAS No. 2082-79-3.
Irganox 1425 is Calcium-bis(((3,5-bis(1,1-dimethylethyl)-4-hydroxyphenyl)methyl)-ethylphosphonate)
Irganox E201 is 3,4-Dihydro-2,5,7,8-tetramethyl-2-(4,8,12-trimethyltridecyl)-2H-1-benzopyran-6-ol. CAS No. 65140-91-2
Irgafos 168 is Tris(2,4-di-tert-butylphenyl)phosphite; CAS No. 31570-04-4.
Tinopal OB is 2,5-thiophenediylbis(5-tert-butyl-1,3-benzoxazole); CAS No. 7128-64-5.

### Inventive Ethylene-Based Compositions 1-7

Inventive ethylene-based compositions 1-7 (IEC 1-7) were melt-blended and formed into pellets via extrusion process based on the formulation components listed in Table 1 via melt blending process. IEC 1-7 were tested for their properties according to the test methods described below, and the results (after 3 extrusions at 240° C.) are reported in Tables 2-4.

### Comparative Ethylene-Based Compositions 1-3

Comparative ethylene-based compositions 1-3 (CEC 1-3) were melt-blended and formed into pellets via extrusion process based on the formulation components listed in Table 1 via melt blending process. CEC 1-3 were tested for their properties according to the test methods described below, and the results (after 3 extrusions at 240° C.) are reported in Tables 2-4.

TABLE 1

| | Comparative ethylene- | | | | | | | | | |
|---|---|---|---|---|---|---|---|---|---|---|
| | based compositions | | | Inventive ethylene-based compositions | | | | | | |
| | CEC-1 | CEC-2 | CEC-3 | IEC-1 | IEC-2 | IEC-3 | IEC-4 | IEC-5 | IEC-6 | IEC-7 |
| LLDPE | LLDPE-1 | LLDPE-1 | LLDPE-2 | LLDPE-1 | LLDPE-1 | LLDPE-1 | LLDPE-1 | LLDPE-1 | LLDPE-2 | LLDPE-2 |
| ppm | 225 | 220 | — | — | — | — | 220 | 220 | — | — |
| Irganox | | | | | | | | | | |
| 1010 | | | | | | | | | | |
| ppm | — | 150 | 200 | — | — | — | — | — | — | — |
| Irganox | | | | | | | | | | |
| 1076 | | | | | | | | | | |
| ppm | — | 750 | 1000 | — | — | — | — | — | — | 250 |
| Irgafos | | | | | | | | | | |
| 168 | | | | | | | | | | |
| ppm | — | — | 400 | — | — | — | — | — | 400 | 400 |
| Irganox | | | | | | | | | | |
| 1425 | | | | | | | | | | |
| ppm | — | — | — | 150 | 150 | 250 | 200 | 200 | 200 | 100 |
| Irganox | | | | | | | | | | |
| E201 | | | | | | | | | | |
| ppm | — | — | — | — | 12.5 | 25 | — | 20 | 20 | — |
| Tinopal | | | | | | | | | | |
| OB | | | | | | | | | | |
| ppm | 225 | 1120 | 1600 | 150 | 150 | 250 | 440 | 440 | 600 | 750 |
| Total | | | | | | | | | | |
| AO | | | | | | | | | | |

TABLE 2

| | CEC-1 | IEC-1 | IEC-2 | IEC-3 |
|---|---|---|---|---|
| OIT | 9 | 12 | 10 | 12 |
| GEL area (after 3 extrusions at | 89 | 27 | 15 | 19 |
| 240° C.) | | | | |
| I_{2.16} | 0.93 | 0.83 | 1.00 | 1.02 |
| I_{10.0}/I_{2.16} | 7.99 | 8.12 | 7.89 | 7.91 |
| I_{2.16} (after 3 extrusions at 240° C.) | 0.24 | 0.56 | 0.67 | 0.72 |
| I_{10.0}/I_{2.16} (after 3 extrusions at | 17.46 | 9.78 | 9.43 | 9.33 |
| 240° C.) | | | | |
| Color: | | | | |
| YI* | −9.81 | −7.66 | −15.8 | −20.1 |
| YI* after ageing | 61.4 | 41.7 | 55.3 | 37.5 |
| YI | 0.67 | 2.44 | −7.33 | −11.67 |
| YI after 3 extrusion steps | 6.37 | 8.08 | −4.99 | −3.94 |

TABLE 3

| | CEC-2 | IEC-4 | IEC-5 |
|---|---|---|---|
| OIT | 23 | 31 | 30 |
| GEL area | 40 | 21 | 31 |
| I_{2.16} | 0.99 | 0.98 | 0.99 |
| I_{10.0}/I_{2.16} | 7.66 | 7.55 | 7.61 |
| I_{2.16} (after 3 extrusions at | 0.57 | 0.71 | 0.68 |
| 240° C.) | | | |
| I_{10.0}/I_{2.16} (after 3 extrusions | 10.1 | 9.1 | 9.3 |
| at 240° C.) | | | |
| Color: | | | |
| YI* | −9.3 | −8.0 | −22.8 |
| YI* after ageing | 28.5 | 4.83 | 22.1 |
| YI | 2.3 | 1.6 | −11.0 |
| YI (after 3 extrusions at | 6.4 | 8.9 | −2.3 |
| 240° C.) | | | |

TABLE 4

| | CEC-3 | IEC-6 | ICE-7 |
|---|---|---|---|
| OIT | 32 | 28 | 32 |
| GEL area | 202 | 134 | 115 |
| I_{2.16} | 0.90 | 0.89 | 0.90 |
| I_{10.0}/I_{2.16} | 7.91 | 7.97 | 7.87 |
| I_{2.16} (after 3 extrusions at | 0.70 | 0.57 | 0.66 |
| 240° C.) | | | |
| I_{10.0}/I_{2.16} (after 3 extrusions | 8.8 | 9.9 | 9.2 |
| at 240° C.) | | | |
| Color: | | | |
| YI* | −9.9 | −23.5 | −10.1 |
| YI* after ageing | 20.0 | 3.7 | 11.2 |
| YI | −0.2 | −12.7 | 1.5 |
| YI after (after 3 extrusions at | 5.2 | −6.4 | 4.8 |
| 240° C.) | | | |

### Test Methods

Test methods include the following:

Density was measured according to ASTM D-792-03, Method B, in isopropanol.

Melt index was measured at 190° C. under a load of 2.16 kg (12.16) and under a load of 10 kg (I_{10.0}) according to ASTM D-1238-03 except that the samples were preheated for five minutes instead of seven minutes.

The Oxygen Induction Time (OIT) is a thermal degradation technique. The OIT is measured according to ASTM D3985. The following parameters are used: Temperature 200° C., type pan: Aluminum, purge gas: Oxygen 4.5, tangent method.

Gel Area (GI 200) in mm2, per 24.6 cm3: DOWM 101898

Yellowness Index (YI) was measured on pellets according to ASTM D-6290 using a Minolta CM-2600 d instrument. A positive number refers to a resin measuring a higher yellowness, and a more negative number is indicative of a lower yellowness.

Oven aging tests were carried out in a circulating air oven at 200° C. on 1 mm thick compression molded (20 cm×26 cm) plaques put in aluminum trays. In such a tray a Teflon® sheet is placed to easily release the cooled polymer from the tray. Specimens are removed at various times and allowed to cool before measuring with a Minolta CM-2600 d instrument. The Yellow index (YI*) is calculated according ASTM D-6290.

The present invention may be embodied in other forms without departing from the spirit and the essential attributes thereof, and, accordingly, reference should be made to the appended claims, rather than to the foregoing specification, as indicating the scope of the invention.

We claim:

1. An ethylene-based composition comprising:
a. a linear low density polyethylene (LLDPE) comprising units derived from ethylene and optionally one or more alpha-olefin comonomers;
b. from 20 to 500 part by weight of a primary antioxidant comprising 3,4-Dihydro-2,5,7,8-tetramethyl-2-(4,8,12-trimethyltridecyl)-2H-1-benzopyran-6-ol per one million parts of LLDPE;
c. optionally from 2 to 200 part by weight of an optical brightening agent; and
d. optionally from 20 to 1000 part by weight of a secondary antioxidant.

2. A method of improving stabilization of LLDPE comprising the steps of:
a. selecting a linear low density polyethylene (LLDPE) comprising units derived from ethylene and optionally one or more alpha-olefin comonomers;
b. selecting from 20 to 500 part by weight of a primary antioxidant comprising 3,4-Dihydro-2,5,7,8-tetramethyl-2-(4,8,12-trimethyltridecyl)-2H-1-benzopyran-6-ol per one million parts of LLDPE;
c. optionally selecting from 2 to 200 part by weight of an optical brightening agent;
d. optionally selecting from 20 to 500 part by weight of a secondary antioxidant;
e. contacting a-d; and
f. thereby forming a stabilized LLDPE.

3. The method of claim 2, wherein said ethylene-based composition has a yellowness index of −30 to 5.
